(19) United States
(12) Patent Application Publication
(10) Pub. No.: US 2023/0073953 A1
(43) Pub. Date: Mar. 9, 2023

(54) CONCRETE SURFACE TREATMENT SYSTEM AND METHOD

(71) Applicant: Scott Swederski, Spring Grove, IL (US)

(72) Inventor: Scott Swederski, Spring Grove, IL (US)

(21) Appl. No.: 17/466,724

(22) Filed: Sep. 3, 2021

(51) Int. Cl. E01F 9/518; B05D 5/02; B05B 1/04; B05D 1/02; B05B 1/16

(52) U.S. Cl. CPC E01F 9/518; B05D 5/02; B05B 1/04; B05D 1/02; B05B 1/1636

(57) ABSTRACT

A system and method treating a horizontal surface of uncured concrete. The surface treatment system comprises a boom mounted to a vehicle body and an implement mounted to a mounting plated disposed at the working end of the boom. The implement comprises a texturing brush configured to engage a horizontal surface of the uncured concrete to apply a texture pattern thereto. The implement also comprises a first and second spray bars. The first spray bar is configured to apply a first chemical to the bristles of the texturing brush when in an engaged position. The second spray bar is configured to concurrently apply a second chemical to the textured surface of uncured concrete while the texturing brush is applying the texture pattern to the horizontal surface of the uncured concrete.

### FIELD OF THE DISCLOSURE

This disclosure generally relates to concrete preparation, and more specifically, relates to surface treatment concrete surfaces.

### BACKGROUND OF THE DISCLOSURE

After large, uncured concrete slabs are poured, a leveling machine is often drawn across the surface of the freshly poured concrete to control the surface thickness and impart a level surface. The machine typically includes a mobile platform and a screed head. A drag-style screed includes a mobile platform such as a walk-behind, ride-on, or repurposed loader that pulls the screed head directly behind or adjacent. A boom screed includes a turret-style mobile platform with a cantilevered boom such as an articulated knuckle-boom or a horizontal boom. The turret-style platform can rotate the boom to orient the screed head to the desired location and the boom can extend screed head and draw it back towards the platform to level and grade the poured concrete as desired.

A typical screed head includes an auger to agitate and spread the uncured concrete laterally followed by a blade to smooth and grade the surface. The blade may be coupled with a vibration mechanism to further aid in smoothing. The screeding head may include a laser leveling mechanism to track a desired grade.

After leveling, a texture may be applied to the leveled surface prior to curing to improve traction for walking surfaces or reduce tire noise for driving surfaces. While texture/curing machines exist, for example, U.S. Pat. No. 8,118,518 B2, they are large machines designed to straddle roads. For smaller applications such as flooring or parking lots where a boom screed would be used to level the flooring, truss-style texturing curing machine would be impracticable. Thus, texturing a smaller leveled surface requires manually imparting the texture with a broom or a similar technique. However, manual texturing is slow, expensive, and inconsistent. There exists a need for a machine configured to texture and dispose a chemical agent to a smoothed, leveled concreted surface.

The present disclosure is directed at addressing one or more of the deficiencies and disadvantages set forth above.

### SUMMARY OF THE DISCLOSURE

In one example of the present disclosure, an implement for applying a texture pattern and a spray pattern to a horizontal surface is presented. The implement comprises a texturing brush configured to engage a surface and apply a texture pattern to the surface. The implement also comprises a first spray bar and a second spray bar. The first spray bar is configured to apply a first chemical to the texturing brush and comprises a first nozzle assembly configured to spray the first chemical at a first spray pattern. The second spray bar′ is configured to apply a second chemical to the textured surface and comprises a second nozzle assembly configured to spray the second chemical at a second spray pattern.

In another example of the present disclosure, a surface treatment system is presented. The surface treatment system comprises a vehicle body and a boom mounted to the vehicle body. The boom comprises a mounting plate disposed at a working end of the boom opposite the vehicle body. Removably attached to the mounting plate is an implement that comprises a texturing brush configured to engage a surface and apply a texture pattern to the surface. The implement also comprises a first spray bar and a second spray bar. The first spray bar is configured to apply a first chemical to the texturing brush and comprises a first nozzle assembly configured to spray the first chemical at a first spray pattern.

The second spray bar is configured to apply a second chemical to the textured surface and comprises a second nozzle assembly configured to spray the second chemical at a second spray pattern.

In another example of the present disclosure, a controller for treating a surface with a sui face treatment system is presented. The controller comprises memory for storing instructions when executed by the controller performs the method comprising the steps of: receiving a desired elevation relative to a horizontal surface; receiving a desired position and extended a boom to the desired position; setting an implement to the desired elevation; setting a texturing brush to an engaged position; supplying a first chemical to a first nozzle assembly and a second chemical to a second nozzle assembly; and retracting the boom in a working direction while concurrently applying a texture pattern to the horizontal surface with the engaged texturing brush while concurrently spraying the second chemical in a second spray pattern onto the textured horizontal surface.

### BRIEF DESCRIPTION OF THE DRAWINGS

FIG. 1 is an illustration of a first perspective view of a machine with a surface treatment system in accordance with an illustrative embodiment;

FIG. 2 is another perspective view of the machine with the surface treatment system in accordance with the illustrative embodiment;

FIG. 3 is a perspective view of an implement of the surface treatment system in accordance with the illustrative embodiment;

FIG. 4 is a schematic diagram of the sui face treatment system in accordance with the illustrative embodiment; and

FIG. 5 is a flow chart for treating a surface with the surface treatment system in accordance with the illustrative embodiment.

### DETAILED DESCRIPTION

This disclosure relates to a surface treatment system configured to concurrently apply a texture pattern and spray a chemical curing agent to a leveled and smoothed horizontal sin face of an area of uncured concrete.

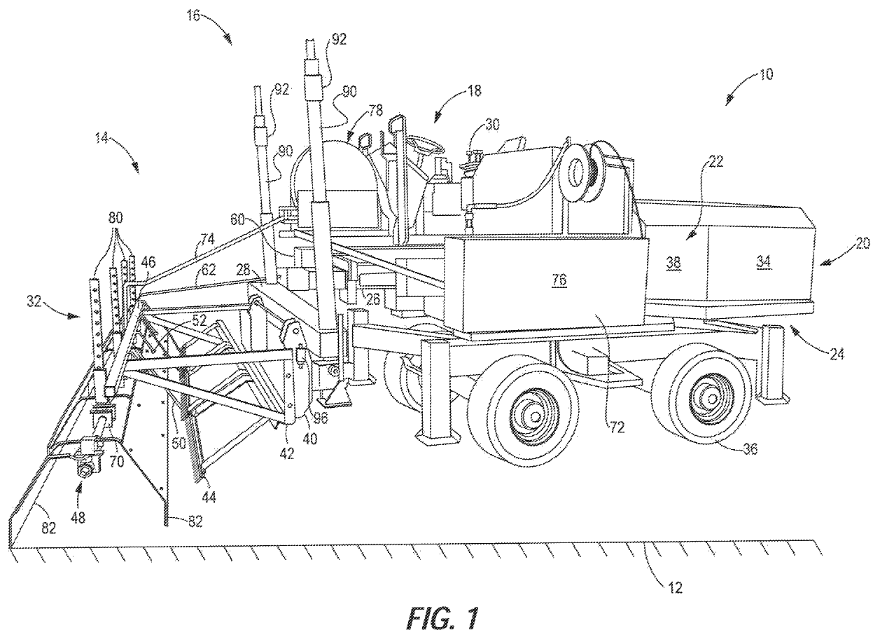

Now referring to the drawings, wherein like reference numerals refer to like elements, illustrated in FIG. 1 is a machine 10 which is configured to texture and apply the chemical spray to the horizontal surface 12 which has been leveled and smoothed in a preceding step. The horizontal surface 12 way be an area of uncured concrete that has been poured and spread over an area such as a floor of a building interior or an outdoor lot. However, it should be appreciated materials other than uncured concrete may also receive a surface treatment in accordance with the preferred embodiment. In the preferred embodiment, the machine 10 may be a turret-type telescoping boom screeding machine, but other construction-type machines are also contemplated. For example, the machine 10 may be a stationary or a mobile machine with various types of booms, such as a knuckle-type boom, an articulated boom, or the like, mounted thereto based on the work environment of the horizontal surface 12.

The machine 10 comprises a surface treatment system 14, a leveling system 16, a control system 18, a power system 20, and a hydraulic system 22. The machine 10 includes a vehicle body 24 which supports a boom 26 that is capable of rotating, extending, retracting, articulating, or any combination thereof a working end 28 of the boom 26 to position the working end 28 to a desired location along a desired trajectory. In the preferred embodiment of a telescoping boom, during a surface treatment operation, an operator can control the machine 10 via a control panel 30 to pull an implement 32 of the surface treatment system 14 across the horizontal surface 12 to concurrently apply the desired texture pattern and apply a desired spray pattern of the a chemical curing agent on to the textured surface.

The power system 20 is configured to generate and supply power to the various components of the machine 10. As part of the power system 20, disposed on the vehicle body 24 is a power source such as an engine 34. The engine 34 may be a conventional internal combustion engine; however, other power sources are also contemplated such as battery-based, fuel cell type, or′ other sources of power not yet contemplated. For mobile machines 10, the engine 34 may be configured to supply motive power to wheels 36 which supports the vehicle body 24, as shown in the illustrated embodiment of FIG. 1, in order to maneuver the machine 10 to a desired location or orientation. The engine 34 may also supply rotational power to the hydraulic system 22. The hydraulic system 22 may comprise a reservoir of hydraulic fluid (not shown) which supplies hydraulic fluid to a hydraulic pump 38. The hydraulic pump 38 pressurizes and supplies the hydraulic fluid to various hydraulic components of the machine 10 through a series of independently controllable hydraulic valves (not shown).

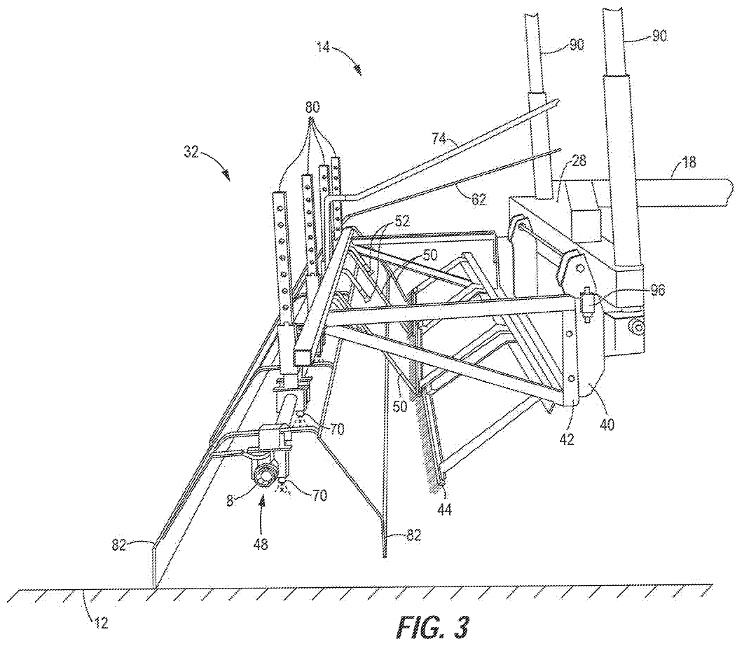

With reference to FIGS. 1-3, the implement 32 of the surface treatment system 14 is removably mounted to a mounting plate 40 disposed at the working end 28 of the boom 26. The implement 32 includes a frame 42 which is mounted to the mounting plate 40 and supports at least a texturing brush 44, a first spray bar 46, and a second spray bar 48. In the illustrated embodiment, the texturing brush 44 includes three individual texturing brushes; however, for the sake of clarity, the at least one texturing brush 44 will be described as a single texturing brush 44 but it should be appreciated that more than one texturing brush 44 is also contemplated. The texturing brush 44 is pivotably mounted to the frame so it can be positioned between an engaged and disengaged position. In the engaged position, the texturing brush 44 engages the horizontal surface 12 to apply a texture pattern based on an arrangement of the bristles of the texturing brush 44. The texturing brush may be positioned between the engaged and disengaged position manually or automatically. When manually positioned, an operator can adjust a linkage 50 which raises the texturing brush 44 to the disengaged position or lowers the texturing brush 44 to the engaged position about a pivot point on the frame 42. When automatically positioned, an actuator (not shown) can mechanically position the texturing brush 44 between the engaged and disengaged positions. The actuator may include a linear actuator configured to manipulate the linkage 50. In another embodiment, the actuator may be a winch-type arrangement that can wind or unwind a cable that acts as the linkage 50 to position the texturing brush 44. It should be appreciated that other types of actuators are also contemplated, such as, but not limited to, mechanical, pneumatic, hydraulic, electric, and the like. The actuator may be controlled by an operator via the control panel 30 of the control system 18.

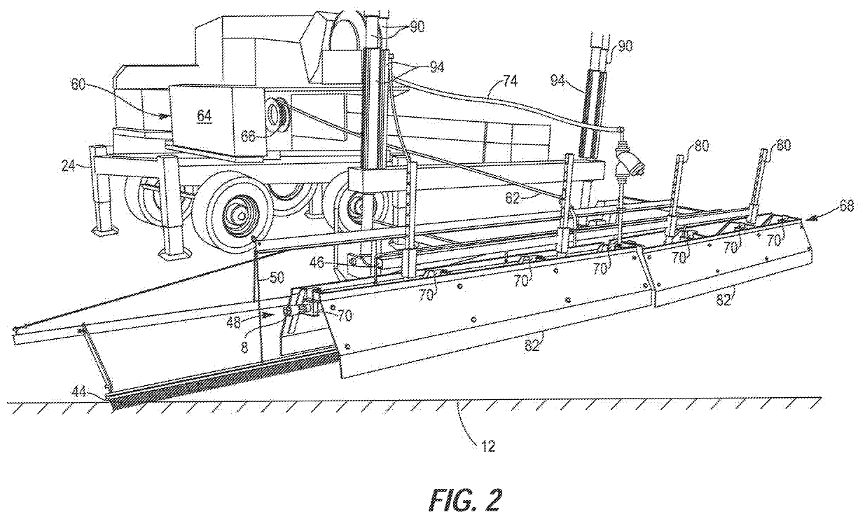

The first spray bar 46 includes a first nozzle assembly 52 which is configured to spray a first chemical in a predefined first spray pattern and flow onto the texturing brush 44 when the texturing brush 44 is in the engaged position. The first nozzle assembly 52 comprises at least one first nozzle 54. In the illustrated embodiment, the nozzle assembly 52 is illustrated with four individual first nozzles 54; however, it should be appreciated that the nozzle assembly 52 may comprise more than one nozzle 54. During operation, as the implement 32 is pulled across the horizontal surface 12, the uncured concrete may build up on the texturing brush 44 as it applies the texture pattern. The first spray bar 46 is configured to spray the first chemical in the first spray pattern substantially onto just the bristles of the texturing brush 44 to remove the buildup of uncured concrete while minimizing the deposition of the first chemical only the textured horizontal surface 12. In a preferred embodiment, the first chemical is water and, for the sake of clarity, will be described as water hereon. The first spray bar 46 is supplied with a flow of water from the first reservoir 60 via a first hose 62. A first pump 64, shown in FIG. 2, is disposed within the first reservoir 60, is configured to supply the flow of pressurized water to the first spray bar 46. The first pump 64 may be controlled by the operator via the control panel 30 of the control system 18 to control the flow of water. An optional electronically controlled first valve (not shown) may also be disposed between the first pump 64 and the first hose 62 to selectively control the flow of pressurized water to the first nozzle assembly 52. Alternatively, the water may be gravity fed from the reservoir to the first spray bar 44 as well. A first hose real 66 may be disposed on the vehicle body 24 to automatically control the length of the first hose 62 as the boom 26 is extended or detracted.

The second spray bar 48 includes a second nozzle assembly 68 configured to spray a second chemical in a predefined second spray pattern onto the textured horizontal 12. The second nozzle assembly comprises at least one second nozzle 70. In the illustrated embodiment, the second spray bar 48 is illustrated with seven individual second nozzles 70; however, it should be appreciated that more than one second nozzle 70 is also contemplated. During operation, as the implement 32 is pulled across the horizontal surface 12, the second spray bar 48 is configured to concurrently apply the second chemical to the textured horizontal surface 12. In a preferred embodiment, the second chemical is a curing agent and, for the sake of clarity, will be described as a curing agent hereon. The second spray bar 48 is supplied with a flow of the curing agent from a second reservoir 72 via a second hose 74. A second pump 76, shown in FIG. 1 as disposed within the second reservoir 72, is configured to supply the flow of pressurized curing agent to the first spray bar 48. The first pump 76 may be controlled by the operator via the control panel 30 of the control system 18 to control the flow of the curing agent. An optional electronically controlled second valve (not shown) may also be disposed between the second pump 76 and the second hose 74 to selectively control the flow of pressurized curing agent to the second nozzle assembly 68. Alternatively, the curing agent may also be gravity fed from the second reservoir 72 to the second spray bar 48 as well. A second hose real 78 may be disposed on the vehicle body 24 to automatically control the length of the first hose 62 as the boom 26 is extended or retracted.

Each second nozzle 70 may include an adjustment mechanism (not shown) to adjust at least one of a shape, size, or flow of the second spray pattern. In the preferred embodiment, the second spray pattern is a flat fan spray pattern; however, other spray patterns are also contemplated. The adjustment mechanism may include a plurality of rotatable nozzles which each imparts a differing spray patter, an atomization adjustment such as a twist adjustment disposed at the nozzle exit, or the like. The second spray pattern can also be adjusted by adjusting the height of the second spray bar 48 relative to the frame 42 via adjustment shafts 80. At least one adjustment shaft 80 is disposed between the frame 42 and the second spray bar 48 to raise or lower the height of the second spray bar 48 until the desired second spray pattern is achieved. In the preferred embodiment, two height adjustment shafts 80 are disposed at opposite lateral ends of the frame 42. The second spray bar 48 is flanked by forward and rear windscreens 82 to block any wind that may affect the second spray pattern to ensure that the second spray pattern is efficiently applied to the textured horizontal surface in order to reduce waste.

As previously mentioned, during operation the working end 28 is pulled towards the vehicle body 24 when applying the texture pattern and spraying the curing agent to the horizontal surface 12. In this preferred embodiment, the texturing brush 44 is arranged on the frame 42 closest to the vehicle body 24 and the second spray bai 48 is arranged furthest from the vehicle body with the second spray bar 46 arranged therebetween. In this arrangement, the working direction is towards the vehicle body 24. As the working end 28 is pulled in the working direction, the texture pattern is applied ahead of the curing agent is subsequently applied to the textured horizontal surface 12 to ensure optimal curing of the uncured concrete. It should be appreciated that it may be advantageous to have the working direction away from the vehicle body 24. In this alternative embodiment, the working end 28 is pushed away from the vehicle body 24 when applying the texture pattern and spraying the curing agent. In both working directions, the texturing brush 44 precedes the second spray bar 48 even though the texture pattern and the second spray pattern are applied to the horizontal surface concurrently. The order of the texturing brush 44, first spray bar 46, and second spray bar 48 may be modified to correspond with the working direction of the working end 28 during operation such that the texture pattern 1s still applied ahead of the curing agent.

The leveling system 16 is configured to accurately level the working end 28 to ensure the orientation of the implement 32 relative to the smoothed and leveled horizontal surface is maintained during the surface treatment operation. By maintaining proper orientation, the surface treatment system 14 can apply the texture pattern and the second spray pattern to the horizontal surface 12 accurately, evenly, and consistently resulting in a uniform textured and treated horizontal surface 12. The leveling system 16 includes a pair of masts 90 disposed on the working end 28 that each carries a laser receiver 92 that is configured to receive a reference laser beam transmitted by a laser transmitter (not shown). At least one cylinder 94 is disposed between the working end 28 and the mounting plate 40 to adjust the elevation of the implement 32 relative to the horizontal surface 12. In the preferred embodiment, a hydraulic cylinder 94 is disposed at each lateral end of the working end 28 opposite one another. It should be appreciated that other leveling systems or combinations thereof are also contemplated. For example, the mounting plate 40 may include an orientation sensor 96 that generates an orientation signal corresponding to the orientation of the implement 32.

In the preferred embodiment, the laser transmitter transmits a rotating laser beam that is referenced to at least one of the horizontal surface 12 or a predefined grade. The lasers receivers 92 detects the laser beam and transmits a detection signal to the control system 18. The control system 18 is configured to detect variations between the detected laser beams at the receivers 92 and generate control signals to control the hydraulic system 22 which in turn supplies hydraulic pressure independently to each hydraulic cylinder 94. The leveling system 16 and the control system 18 ensures that the implement 32 maintains a desired relative orientation during the surface treatment operation in accordance with a predetermined level or grade of the previously smoothed and leveled horizontal surface 12.

The hydraulic cylinders 94 are arranged vertically at opposite ends of the working end 28 to adjust the relative elevation of the implement 32 during the surface treatment operation. The control system 18 may also receive the orientation signal generated by the orientation sensor 96 and determines the relative orientation based on a combination of the detection signal from the laser receivers 92 and the orientation signal from the orientation sensor 96. It should be appreciated that the control system 18 can generate elevation control signals based on the laser detection signals, orientation signals, or any combination thereof.

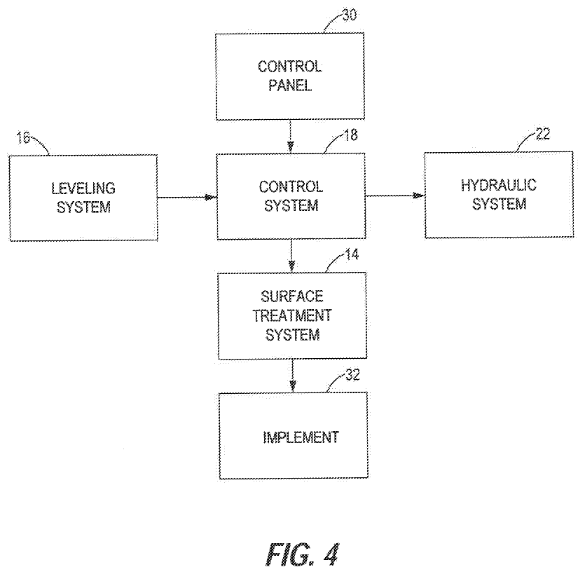

With reference to FIG. 4, the control system 18 is operatively connected to the surface treatment system 14, the leveling system 16, the hydraulic system 22, and the power system 20. The control system 18 is configured to generate electrical control signals that selectively control the various system of the machine 10. The control system 18 may include a processor or controller 100, such as a microprocessor, application-specific integrated circuit (ASIC), or other appropriate circuitry for performing logic and digital functions, and may have associated data storage capabilities for storing instructions executed by the processors. The control system 18 may include discrete, individual units, or their functions may be distributed over a plurality of distinct components. The control system 18 may operate and communicate via various means such as digital signals, analog signals, or through any other suitable means and may communicate with the various systems via wired connections or wireless connections through radio frequency or Wi-Fi mediums.

The control system 18 is configured to receive commands from an operator via the control panel 30. The control panel 30 may include a plurality of suitable input devices (not shown) such as, but not limited to, buttons, toggles, levers, joysticks, steering wheel, and/or touchscreen display with a corresponding graphical user interface (GUI). For example, the control system 18 may have input devices to control the first pump 64 and the second pump 76 of the surface treatment system 14 to supply the water to the first spray bar 46 and/or the curing agent to the second spray bar 48. The control system 18 may also have input devices that control the actuation of the texturing broom 44; enable or disable the leveling system 16; control the rotation, extension, and retraction of the boom 26; control the maneuvering wheels 36, and the like.

### INDUSTRIAL APPLICABILITY

In general, the present disclosure finds utility in concrete formation. In particular, the present disclosure provides a cost-efficient and accurate solution for concurrently applying a texture pattern and applying a curing agent to a previously smoothed and leveled area of recently poured and uncured concrete. Typically, an area of uncured concrete is smoothed and leveled with a traditional screeding machine and then manually textured with handled or handleless brushes. Manually brushing can incur costly manhours and is prone to errors and inconsistencies which can lead to poorly textured surfaces that don't provide a durable, high-traction surface. Once the area of uncured concrete is manually textured, a curing agent is also manually sprayed onto the textured surface. The curing agent creates a semipermeable membrane that ensures the surface of the textured concrete does not cure too quickly relative to the subsurface uncured concrete. However, manual application of the curing agent can be prohibitively costly because of the required manhours and the inefficient application of the curing agent.

The surface treatment system 14 of the present disclosure provides an accurate and efficient alternative to manual texturing and chemical treatment of the textured surface. It should be appreciated that various chemicals other than curing agents can be applied via the second spray bar 48 such as, but not limited to, sealing agents, stains, texturing compounds, release agents, surface retarders and the like.

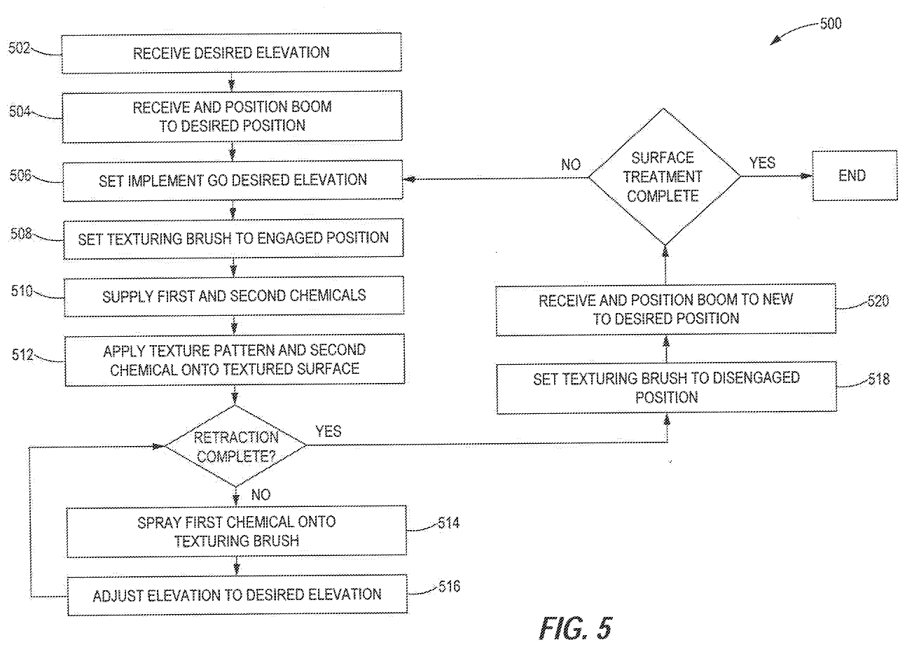

With reference to FIG. 5, a flow chart 500 for treating a horizontal surface 12 with the surface treatment system 14 with the machine 10 to apply the texture pattern and spraying the second chemical thereto. The controller 100 is configured with instructions stored in memory, when executed by the controller 100, performs the method steps illustrated in FIG. 5. At step 502, the controller receives a desired elevation relative to the horizontal surface 12. The desired elevation may correspond with at least one of an elevation or grade of the previously leveled and smoothed horizontal surface 12. An operator may input the desired elevation at the control 18 using any one of the various input devices such, for example, the GUI of the touchscreen display. At step 504, the controller receives a desired position from an operator input at the control panel 30 and positions the implement 32 to the desired position. In response to a received input from the operator, the controller 100 may control the hydraulic system 22 to supply pressurized hydraulic fluid to the boom 26 to extend the boom 26 to the desired position. At step 506, the controller 100 sets the implement 32 to the desired elevation. The controller 100 may control the hydraulic system 22 to supply pressurized hydraulic fluid to the at least one hydraulic cylinders 94 of the leveling system 16 to set the implement 32 to the desired elevation. At step 508, the controller 100 is configured to set the texturing brush 32 from the disengaged position to the engaged position. In one embodiment, the controller may generate and transmit a control signal to the actuator′ to automatically actuate the texturing brush from the disengaged position to the engaged position. In another embodiment, the controller 100 may generate a prompt at the control panel 30 to instruct the operator to manually set the texturing brush 32 from the disengaged position to the engaged position.

At step 510, the controller is configured to supply the first chemical to a first nozzle assembly and second chemical to a second nozzle assembly. At step 512, the controller is configured to retract the boom in the working direction while concurrently applying the texture pattern to the horizontal surface 12 with the engaged texturing brush 44 while spraying the second chemical in a second spray pattern onto the textured horizontal surface 12. The controller 100 may generate and transmit a control signal to the second valve, such as a solenoid valve, disposed between the second nozzle assembly 68 and the second pump 76 to initiate spraying of the second chemical. Alternatively, the controller 100 may generate and transmit a control signal to the second pump 76 to initiate spraying of the second chemical.

At step 514, during retraction, the controller 100 may be configured to intermittently spray the first chemical onto the texturing brush to rinse away any uncured concrete that may build up onto the bristles of the texturing brush as a result of the surface treatment. The controller 100 may be configured to automatically spray the first chemical intermittently onto the texturing brush or the controller may spray the first chemical in response to a received input from the operator at the control panel 30, Similarly, the controller 100 may generate and transmit a control signal to the first valve, such as a solenoid valve, disposed between the first nozzle assembly 52 and the first pump 64 to initiate spraying of the first chemical. Alternatively, the controller 100 may generate and transmit a control signal to the first pump 64 to initiate spraying of the first chemical.

At step 516, during retraction, the controller 100 may be configured to receive detection signals from the leveling system 16 and detect variations between concurrent detection signals that may indicate that the implement 32 is no longer at the desired elevation. The controller 100 may be configured to generate and transmit control signals to the hydraulic system 22 to supply pressurized hydraulic fluid to the at least one hydraulic cylinder 94 to adjust the elevation of the implement 32 to the desired elevation based on the detected variations.

At step 518, upon completion of the retraction, the controller 100 may be configured to set the texturing brush to a disengaged position. Similarly, the controller 100 may be configured to automatically set the texturing brush to the disengaged position or prompt the operator the manually set the texturing brush to the disengaged position. At step 520, the controller 100 is configured to receiving a new desired position and extended the boom 26 to the new desired position. At step 522, the controller 100 is configured to repeat the steps of 506-520.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and ai e not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. An implement for applying a texture pattern and a spray pattern to a concrete surface, comprising:
a texturing brush configured to engage a surface and apply a texture pattern to the surface;
a first spray bar configured to apply a first chemical to the texturing brush, the first spray bar having a first nozzle assembly configured to spray the first chemical at a first spray pattern;
a second spray bar configured to apply a second chemical to the textured horizontal surface, the second spray bar having a second nozzle assembly configured to spray the second chemical at a predefined spray pattern.

2. The implement of claim 1, wherein the texturing brush precedes the second spray bar in a working direction such that the second chemical is applied to the textured horizontal surface.

3. The implement of claim 1, wherein the implement further comprises an actuator configured to pivot the texturing brush between an engaged position and a disengaged position.

4. The implement of claim 1, wherein the second nozzle assembly comprises a plurality of second nozzles, each second nozzle having an adjustment mechanism to adjust at least one of a shape, size, or flow of the second spray pattern.

5. The implement of claim 1, further comprising:
a frame configured to support at least the texturing brush, first spray bar, and second spray bar;
a forward and rear windscreen flanking the second spray bar; and
at least one height adjustment shaft disposed between the second spray bar and a frame to adjust the relative height therebetween.

6. The implement of claim 1, wherein the concrete surface is horizontally disposed.

7. A concrete surface treatment system, comprising:
a vehicle body;
a boom mounted to the vehicle body and having a mounting plate at a working end opposite the vehicle body;
an implement attached to the mounting plate, the implement comprising: a texturing brush configured to engage a sui face and apply a texture pattern to the surface,
a first spray bar configured to apply a first chemical to the texturing brush, the first spray bar having a first nozzle assembly configured to spray the first chemical at a predefined first spray pattern, and a second spray bar configured to apply a second chemical to the textured surface, the second spray bar having a second nozzle assembly configured to spray the second chemical at a predefined second spray pattern.

8. The surface treatment system according to claim 6, wherein the texturing brush precedes the second spray bar in a working direction such that the second chemical is applied to the textured surface.

9. The surface treatment system according to claim 6, wherein the implement further comprises an actuator configured to pivot the texturing brush between an engaged position and a disengaged position.

10. The surface treatment system according to claim 6, further comprising:
a first reservoir disposed on the vehicle body for storing the first chemical;
a first pump configured to pressurize the first chemical from the reservoir and deliver the pressurized first chemical to the first spray bar a second reservoir disposed on the vehicle body for storing the second chemical; and a second pump configured to deliver a pressurized flow of the second chemical to the second spray bar.

11. The surface treatment system according to claim 6, wherein the second nozzle assembly comprises a plurality of second nozzles, each second nozzle having an adjustment mechanism to adjust at least one of a shape, size, or flow of the second spray pattern.

12. The surface treatment system according to claim 6, further comprising:
at least one first hydraulic cylinder disposed between the working end and the mounting plate to adjust the elevation of the implement relative to the surface;
a hydraulic system configured to supply pressurized hydraulic fluid to the at least one hydraulic cylinder, and
a controller configured to control the hydraulic system to selectively control the supply of pressurized hydraulic fluid to the at least one hydraulic cylinder to control the elevation of the implement.

13. The surface treatment system according to claim 11, further comprising a leveling system comprising:
a laser transmitter configured to generate a reference laser beam;
a pair of masts disposed on the working end, each mast having a laser receiver configured to detect the reference laser beam; and
wherein the controller is configured to detect variations between the laser receivers of the detected reference laser beam, and adjust the elevation of the implement based on the detected variations.

14. The surface treatment system according to claim 6, wherein the surface comprises an area of uncured concrete, the first chemical is water for rinsing away uncured concrete build up on the texturing brush, the second chemical is a curing agent for application to a textured surface of uncured concrete.

15. A controller for treating a concrete surface with a surface treatment system, wherein the controller comprises memory for storing instructions when executed by the processor performs the method comprising the steps of:
receiving a desired elevation relative to a horizontal surface;
receiving a desired position and extended a boom to the desired position; setting an implement to the desired elevation;
setting a texturing brush to an engaged position;
supplying a first chemical to a first nozzle assembly and a second chemical to a second nozzle assembly; and
retracting the boom in a working direction while concurrently applying a texture pattern to the horizontal surface with the engaged texturing brush while concurrently spraying the second chemical in a second spray pattern onto the textured horizontal surface.

16. The controller of claim 14, wherein during retraction, the method further comprises intermittently spraying the first chemical onto the texturing brush to rinse away build up.

17. The controller of claim 14, wherein during retraction, the method further comprises:
receiving detection signals from a leveling system; detecting variations between concurrent detection signals;
adjusting an elevation of the implement to the desired elevation based on the detected variations.

18. The controller of claim 14, wherein upon completion of the retraction, the method further comprises setting the texturing brush to a disengaged position.

19. The controller of claim 14, wherein upon completion of the retraction, the method further comprises:
receiving a new desired position and extended the boom to the new desired position; and
repeating the steps of setting an implement to the desired elevation; setting a texturing brush to an engaged position; supplying the first chemical to the first nozzle assembly and the second chemical to the second nozzle assembly; and retracting the boom in the working direction while concurrently applying the texture pattern to the horizontal surface while spraying the second chemical onto the textured horizontal surface.

20. The controller of claim 14, wherein the texturing brush precedes the second spray bar in the working direction such that the second chemical is applied to the textured surface.
